(19) United States
(12) Patent Application Publication
(10) Pub. No.: US 2011/0007955 A1
(43) Pub. Date: Jan. 13, 2011

(54) Apparatus and Method for Barcoded Magnetic Beads Analysis

(75) Inventors: Winston Z. Ho, Hacienda Heights, CA (US); John Collins, Irvine, CA (US); Chung-Jen Hou, Pensacola, FL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: APPLIED BIOCODE INC., Santa Fe Springs, CA (US)

(21) Appl. No.: 12/832,972

(22) Filed: Jul. 8, 2010

Related U.S. Application Data
(60) Provisional application No. 61/224,020, filed on Jul. 8, 2009.

(51) Int. Cl. G06K 9/00

(52) U.S. Cl. 382/128

(57) ABSTRACT

A Light Transmitted Assay Beads or digital magnetic microbead having a digitally coded structure that is partially transmissive and opaque to light. When hundreds or thousands of LITAB are settled down to the bottom of a microwell in a microplate or a planar surface, the barcode can be decoded by image processed accurately and reliable. Microplate is a standard bioassay format; each plate can have 96, 384, or 1536 patient samples. Therefore, a large number of targets in a sample can be analyzed in one single microwell. The image decoding algorithms comprise of four main processes (1) enhancement of image (2) segmentation of beads (3) extraction of barcode slits, and (4) decoding of barcodes. The bead image is taken from the bottom of an optically clear microplate, and barcode pattern can be decoded by image software. Therefore, the whole bead bioassay experiment can be performed in the microplate without taking the beads out.

### CROSS REFERENCE TO RELATED APPLICATION

This application claims the benefit of U.S. Provisional Application No. 61/224,020 filed Jul. 8, 2009, and is entirely incorporated by reference herein.

### TECHNICAL FIELD

The invention relates to carry out multiplexed bioassay with hundreds or thousands of digital magnetic barcode microbeads for proteins, nucleic acids, and molecular diagnostics; and more particularly an optical image decoding algorithm and method to rapidly and simultaneously analyze the barcodes of beads in a small microwell, such as a microplate. The digital magnetic bead is a non-spherical, non-traditional latex microsphere allowing a high density optical pattern to be imaged and identified accurately.

### BACKGROUND

As current research in genomics and proteomics require multiplexed data, there is a need for technologies that can rapidly screen a large number of targets, such as nucleic acids and proteins, in a very small volume of samples. Microarray, DNA chips, and protein chips, with the ability to screen thousands or millions of targets on a planar platform, require a large volume of sample to cover the large surface. The typical surface area is 1 cm×1 cm or on a microslide. Distributing a small volume of liquid samples over a relatively large chip surface often encounters the disadvantages of slow diffusion of molecules and non-uniform mixing or distribution over the chip surface. These are the reasons microarray assays require a very long reaction time. Furthermore, a microarray chip, once it is printed and fabricated, is impossible to add one more test into a multiplexed assay.

Micro bead technology potentially overcomes many of the problems of microarray technology and provides flexibility of library content and amount of beads or bead type in an analysis. Due to its small volume (in the range of picoliter per bead), thousands of beads can be incubated with a very small amount of sample. A number of encoding strategies have been demonstrated include particles with spectrally distinguishable fluorophore, fluorescent semiconductor quantum dots, and metallic rods with either bar coded color (absorption) stripes or black and white strips. Both fluorescence and barcode color strip beads are identified by optical detection in reflective or emissive configuration. The difficulties of reflection configuration are (1) the optical reflection yield is low, especially when the beads are in micrometer scale, (2) the light collection efficiency is poor, and (3) for fluorescence-based encoded beads, the fluorescence bands are very broad and overlapped, thus limit the potential code number. Another drawback of fluorescence-based bead is that most bead-based assay rely on fluorescence readout, thus creating more fluorescence spectral or intensity interference. In the case of multi-metal (Au, Pt, Ni, Ag, etc) color micro rods, the encoding scheme suffers from the difficulty of manufacturing and the number of colors, based on different metal materials, is limited.

U.S. Pat. No. 6,773,886 issued on Aug. 10, 2004, entire contents of which are incorporated herein by reference, discloses a form of bar coding comprising 30-300 nm diameters by 400-4000 nm multilayer multi metal rods. These rods are constructed by electrodeposition into an alumina mold; thereafter the alumina is removed leaving these small multilayer objects behind. The system can have up to 12 zones encoded, in up to 7 different metals, where the metals have different reflectivity and thus appear lighter or darker in an optical microscope depending on the metal type whereas assay readout is by fluorescence from the target, and the identity of the probe is from the light dark pattern of the barcodes.

U.S. Pat. No. 6,630,307 issued on Oct. 7, 2003, entire contents of which are incorporated herein by reference, discloses semiconductor nano-crystals acting as a barcode, wherein each semiconductor nano-crystal produces a distinct emissions spectrum. These characteristic emissions can be observed as colors, if in the visible region of the spectrum, or may be decoded to provide information about the particular wavelength at which the discrete transition is observed.

U.S. Pat. No. 6,734,420 issued on May 11, 2004, entire contents of which are incorporated herein by reference, discloses an identification system comprising a plurality of identifiable elements associated with labels, the labels including markers for generating wavelength/intensity spectra in response to excitation energy, and an analyzer for identifying the elements from the wavelength/intensity spectra of the associated labels.

U.S. Pat. No. 6,350,620 issued on Feb. 26, 2002, discloses a method of producing a micro carrier by placing a bead between a nickel plate on which the barcode has been electroformed and a second plate, and compressing the barcode onto the surface of the bead to form a microcake-like particle with a barcode.

U.S. Pub. No. US2005/0003556 A1, entire contents of which are incorporated herein by reference, discloses an identification system using optical graphics, for example, bar codes or dot matrix bar codes and color signals based on color information signal for producing the affinity reaction probe beads. The color pattern is decoded in optical reflection mode.

U.S. Pub. No. US2005/0244955. entire contents of which are incorporated herein by reference, discloses a micro-pallet which includes a small flat surface designed for single adherent cells to plate, a cell plating region designed to protect the cells, and shaping designed to enable or improve flow-through operation. The micro-pallet is preferably patterned in a readily identifiable manner and sized to accommodate a single cell to which it is comparable in size.

Magnetic beads are used widely in high throughput automated operation. The magnetic beads, are paramagnetic, that is, they have magnetic property when placed within a magnetic field, but retain no residual magnetism when removed from the magnetic field. This allows magnetic collection of microbeads and resuspension of the beads when the magnetic field is removed. Collection and resuspension of the digital magnetic beads can be repeated easily and rapidly any number of times. The common robotic automation is simply putting a 96-well, 384-well or 1536-well microplate on a magnetic stand facilitated with magnetic pins to activate the magnetic field. This enables washing of unbound molecules from the beads, changing buffer solution, or removing any contaminant in the solution. For example, in the case of DNA or RNA assay, the unbound or non-specific nucleotides can be removed after hybridization. While in the case of protein assay, the unbound or non-specific antibodies or antigens can be removed after the antibody-antigen reaction. Extensive washing often required during molecular biology applications to be conducted swiftly, efficiently, and with minimal difficulty. While magnetic beads are widely used in the bioassays, no magnetic beads with high density barcode are available.

Applicant's prior PCT Patent Application No. PCT/US08/08529 discloses a digitally encoded magnetic micro bead that provides high optical contrast and high signal-to-noise for reliable decoding, and also provides magnetic property for high-throughput automated washing in the microplate format. Such application also discloses a decoding method including a data process that is relatively simple, robust, rapid and accurate. The present invention further improves on the disclosed beads, method and processes.

### SUMMARY

The present disclosure is particularly useful to efficiently analyze a plurality of microbeads, each having an indicia representing a digital code, wherein the image obtained by the imaging device include the plurality of beads, including the indicia on each bead, and wherein the decoding system is configured to analyze the image to recognize and isolate the plurality of beads, and determining the digital code represented by the indicia provided on each bead. By recognizing and isolating each bead from each other and the background in the overall image of the plurality of beads, the digital code represented on each bead can be determined.

In one aspect, a disclosed embodiment is directed to an image processing method for decoding digitally coded beads used in bioassays, which conduct imaging of the beads in their steady or static state. A plurality of beads can be distributed on a planar surface (e.g., a glass microslide), and imaged simultaneously in two dimension with an imaging device (e.g., a wide viewing image camera), thereby allowing a plurality of beads to be decoded to improve detection throughput. The digital encoding may be observable by imaging based on emission, reflection and/or transmission of light with respect to the beads.

In another aspect of the present disclosure, the digital coding of the beads comprises a bar code pattern. The bar code pattern with a series of narrow and wide bands provides an unambiguous signal and differentiation for O's and l's. In one embodiment, the position of the slits on the pallet will determine which of the bits is the least significant (LSB) and most significant bit (MSB). The LSB will be placed closer to the edge of the pallet to distinguish it from the MSB at the other, longer end.

In another embodiment, the bars in the barcode are left aligned for effective barcode decoding. This will help in the improved algorithm design for barcode decoding. The barcode is divided in to sets of bar and space combination. The barcode digits ‘1’ or ‘0’ are computed using the ratio of bar and space in their sets. On the other hand, the center aligned bars of barcode system is also considered.

In the illustrated embodiments, the present disclosure is directed to a Light Transmitted Assay Beads (I,ITAB) or micropallet that is digitally coded as represented by an image that provides for high contrast and high signal-to-noise optical detection to facilitate identification of the bead. The image is implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), the code represented by the image on the coded bead can be decoded. In one embodiment, the coded bead comprises a body having a series of alternating light transmissive and opaque sections, with relative positions, widths and spacing resembling a 1D or 2D bar code image (e.g., a series of narrow slits (e.g., 5 microns in width) representing a “0” code and wide slits (e.g., 10 microns in width) representing a “1” code, or vice versa). To decode the image, the alternating transmissive and opaque sections of the body are scanned and imaged (e.g., with a CCD sensor) to determine the code represented by the image determined from the transmitted light.

In a further aspect of the present disclosure, the digital barcode beads have paramagnetic property, that is, they have magnetic property when placed within a magnetic field, but retain no residual magnetism when removed from the magnetic field. Magnetic beads allow washing in a microplate by collection of beads with an external magnet, and resuspension of beads when the magnetic field is removed. Multiple digital magnetic beads allow multiplexed assays to be performed in a single well. Microplate is a standard high throughput format in clinical diagnostics; each plate has 96, 384, or 1,536 patient samples.

In a further aspect of the present disclosure, a digital magnetic microbead analytical system comprises: (a) a slide or microplate with a plurality of wells; (b) at least one digital magnetic bead on the surface of the slide or settled at the bottom of the wells of the microplate, (c) an optical detector, located above or under the slide or the microplate, imaging the at least one magnetic microbead; and (d) a digital processing system implemented with an image software to process the image pattern of at least one magnetic microbead. In one embodiment, the number of wells is between about 96, 384, or 1536 wells.

In a further aspect of the present disclosure, both bar-code image and fluorescence image are taken under a microscope and camera simultaneously. Therefore, the whole bead experiment can be performed in the microplate without taking the beads out. The barcode is used to identify which molecular probe is immobilized on the bead, while the fluorescence is used to detect the positive or negative reaction. A large number of targets can be analyzed simultaneously.

In a further aspect of the present disclosure, the digital magnetic microbeads comprise a first layer; a second layer; and an intermediate layer between the first layer and the second layer, the intermediate layer having an encoded pattern defined thereon, wherein the intermediate layer is partially substantially transmissive and partially substantially opaque to light, representing a code corresponding to each of the microbeads.

In a further aspect of the present disclosure, the first layer and the second layer of the digital magnetic beads are functionalized with a material selected from the group consisting of proteins, nucleic acids, small molecules, chemicals, and combinations thereof.

In one embodiment, the body of the coded bead may be configured to have at least two orthogonal cross sections that are different in relative geometry and/or size. Further, the geometry of the cross sections may be symmetrical or non-symmetrical, and/or regular or irregular shape. In one embodiment, the longest orthogonal axis of the coded bead is less than 1 mM.

In a further aspect of the present disclosure, the light transmissive sections are defined by slits through the intermediate layer, and the light opaque sections are defined by a light reflective material and/or a light absorptive material. The slits comprise slits of a first width and slits of a second width, and wherein the first width represents a “0” and the second width represents a “1” in a binary code. The first width is about 1 to 10 microns and the second width is about 1 to 50 microns, and wherein the first width is narrower than the second width. The binary codes can be decoded by image software.

In another aspect of the present disclosure, instead of the above “negative” beads in which slits are used to define the barcodes in an opaque background, “positive” beads may provide additional advantage. Positive beads have barcodes defined by opaque bars (e.g., defined by reflective surfaces) in a transparent background. Given the opacity of the bars and the transparent background, a constant width “path” region is defined around the bar region, where fluorescence is measured. This region does not have interference of reflectance of excited light. The MSB and LSB of the barcode are introduced as separate bars for smaller and larger width. In this definition of barcode, no beads will have the same width of bars at both ends.

In another aspect of the present disclosure, to minimize the bead overlap and aggregation on the bottom of the microwell, a detection buffer solution was developed. The detection bulkr is composed of (a) bulky polymer is chosen from natural polysaccharides. or synthetic polymers or copolymers. (b) the compatibilizer is chosen from copolymers containing N-vinyl pyrrolidone (or 1-vinyl-2-pyrrolidone). and (c) surfactant is chosen from silicone surfactants. nuorosurfactants. anionic surfactants, cationic surfactants. or nonionic surfactants or their combination.

In another aspect of the present disclosure, a bright field light source (e.g. a white light 1 . . . [D) is incident from the top of the 96-well plate via a diffuser film or plate to provide uniform illumination. All current 1.+:1)s have speckle patterns or non-uniform light pattern. which cause the non-uniform light distribution and illumination. The situation becomes worse when the light is illuminated near the edge or the wall of the microwell. A light diffuser film has been made and implemented on top of the microwell as a plate sealer or attached on the microplate cover. The diffuser film homogenizes the I . . . , ED light pattern. thus every image frame has uniform background. which leads to much improved decoding accuracy.

In another aspect of the present disclosure is to overlap and image a plurality (5×6=30) of image frames together in order to decode the barcode with high spatial resolution (1 pixel/urn), and also image plurality of beads distributed over a relatively large area (7 mm diameter) on the bottom of a microwell. Furthermore, if two neighboring images after imaged are slightly off in either X or Y direction, the barcode may not be recognizable. Therefore, a novel bead image overlapping method is used. This method is to overlap the each neighboring frame with an overlap of 120 pm (the long axis of the bead+margin) on X and Y direction. Therefore. all heads will “fall fully—in at least one of the frames. instead of lying between the two frames.

In another aspect of the present disclosure two different image processing approaches are implemented for decoding the beads. One is based on segmentation of the bars of the bead and the other is based on a grid search scheme to track the set of bars and the bead. The segmentation based algorithm comprises of five main sub-processes (1) Enhancement of bright field image (2) Grayscale threshold (3) Segmentation and area filtering of bars (4) Dilation and area filtering of beads, and (5) Pattern search and decoding of barcodes. The ‘grid search’ based routine searches the bars in the beads in an image frame in reference to a grid.

### BRIEF DESCRIPTION OF THE DRAWINGS

For a fuller understanding of the scope and nature of the invention, as well as the preferred mode of use, reference should be made to the following detailed description read in conjunction with the accompanying drawings. In the following drawings, like reference numerals designate like or similar parts throughout the drawings.

FIG. 1 illustrates the process for preparing Light Transmitted Assay Beads (LITAB) for bioassay, in accordance with one embodiment of the present invention: (a) Multiple LITAB in a microwell of a microplate, (b) LITAB for bioassay, and (c) a schematic representing a photo image of LITABs;

FIG. 2(a) is a top view of a LITAB in accordance with one embodiment of the present invention;

FIG. 2 (b) is the top view and dimension of rectangular shaped bead which is described in this invention for the image processing;

FIG. 3 illustrates a (a) positive type and (b) negative type of beads. Both patterns are aligned at the left side of the barcodes;

FIG. 4 illustrates the beads with center aligned barcode;

FIG. 5 illustrates the steps of forming a bead in accordance with one embodiment of the present invention;

FIG. 6 illustrates a metal layer as a layer sandwiched between two polymeric layers that may provide the same surface chemistry for molecule immobilization;

FIG. 7 is a schematic illustration of the physical configuration of the instrument system;

FIG. 8(a) is a schematic flow diagram of the image process undertaken by the system instrumentation for bead decoding and fluorescence detection, including overlapping and stitching image frames;

FIG. 8(b) is a flow chart illustrating an example method 200 of imaging and decoding a bead;

FIG. 8(c) illustrates an exemplary flowchart of a segmentation based algorithm 250;

FIG. 8(d) is an exemplary flowchart 260 illustrating an enhancement routine;

FIG. 8(e) is an exemplary flowchart 280 illustrating a possible grayscale processing routine;

FIG. 8(f) is an exemplary flowchart 300 illustrating a routine for performing segmentation and area filter of bars;

FIG. 8(g) is an exemplary flowchart 320 illustrating a routine for performing dilation and area filtering of beads;

FIG. 8(h) is an exemplary flowchart 340 illustrating a routine for performing a pattern search and decoding of barcodes;

FIG. 9 shows the transmitted digital signal of a barcoded bead representing 0011111001 on an image camera;

FIG. 10 (a) illustrates overlapping image frames for one well; (b) is a schematic diagram explaining overlapping image frames to account for partial beads at boundaries; (c) illustrates overlapping image frame data sent to processing module;

FIG. 11 shows the segmentation based algorithm comprises of five main sub-processes (1) Enhancement of bright field image (2) Grayscale threshold (3) Segmentation and area filtering of bars (4) Dilation and area filtering of beads, and (5) Pattern search and decoding of barcodes;

FIG. 12a is a diagram illustrating barcode decoding using a grid search routine in accordance with one embodiment of the present invention;

FIG. 12b is a diagram illustrating bead image determination using a grid search routine in accordance with one embodiment of the present invention;

FIG. 12c is a diagram illustrating bar image determination using a grid search routine in accordance with one embodiment of the present invention;

FIG. 13 is an illustration of fluorescence calculation of the beads using the area between the two concentric rectangles in dotted lines;

FIG. 14 is an exemplary image of decoded beads in a single image frame showing the bead numbers, barcode of the beads and fluorescence value of the beads;

FIG. 15. is an illustration of background correction and thresholding;

FIG. 16 shows area filtering for bars to detects objects equal to the area of larger bars;

FIG. 17 shows filtering with bounding box in order to remove stray objects at the edges of the beads;

FIG. 18 shows dilation of bars in order to detect beads;

FIG. 19 shows area Filtering of beads in order to remove overlapping or partial beads;

FIG. 20 shows geometric matching for barcode detection using computer generated template barcodes;

FIG. 21 illustrates the shortened bead with no spaces between code segment;

FIG. 22 illustrates an example computing device that may be used in an image decoding system;

### DETAILED DESCRIPTION

The detailed descriptions of the process of the present invention are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated.

Useful devices for performing the software implemented operations of the present invention include, but are not limited to, general or specific purpose digital processing and/or computing devices, which devices may be standalone devices or part of a larger system. The devices may be selectively activated or reconfigured by a program, routine and/or a sequence of instructions and/or logic stored in the devices, to accomplish the features and functions of image detection and decoding of the present invention described herein. In short, use of the methods described and suggested herein is not limited to a particular processing configuration.

For purposes of illustrating the principles of the present invention and not by limitation, the present invention is described herein below by reference to a micro bead that is in the shape of a pallet, and by reference to bioanalysis. However, it is understood that the present invention is equally applicable to micro beads of other overall geometries, and which are applied for other applications requiring identification based on the identity of the beads, without departing from the scope and spirit of the present invention. To facilitate discussion below, the micro bead of the present invention is referred to as a LITAB, which stands for a Light Transmitted Assay Beads.

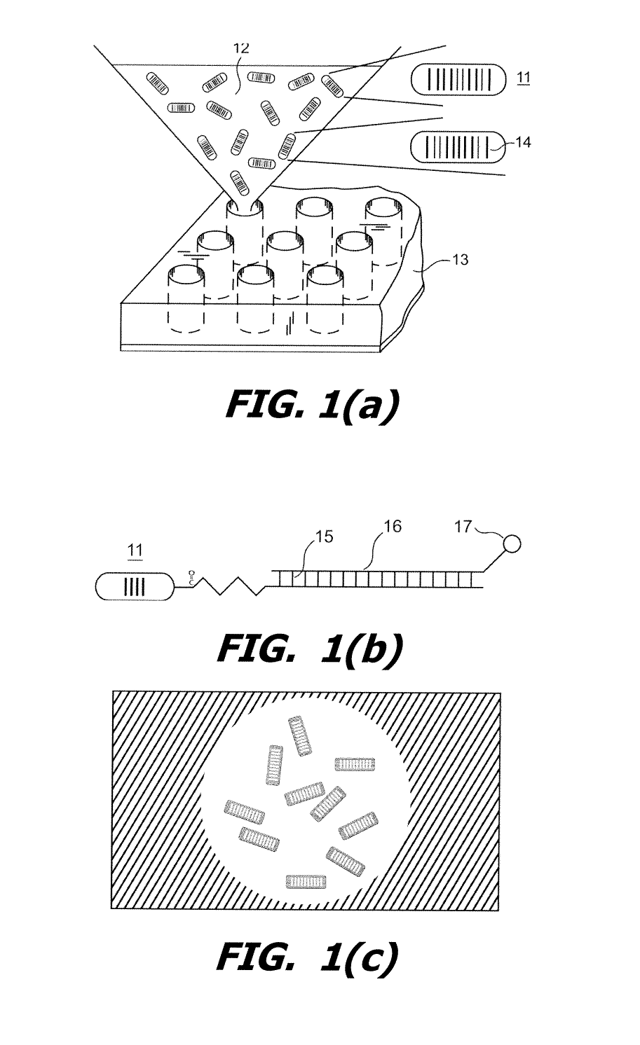

FIG. 1 illustrates an embodiment for preparing LITAB for bioassays. As shown in FIG. 1(a), the LITABs 11 allow multiplexed homogeneous bioassays on micro-volume samples, A mixture of LITABs 11 corresponding to different codes 14 are introduced into a small volume of biological sample 12 in a tube or microwell plate 13. The LITABs can be optically decoded easily and rapidly thereafter. In one embodiment, FIG. 1(b) shows one LITAB II functionalizing with nucleic acid probe 15 for target hybridization 16 and fluorescence detection 17. Several materials are available for bead immobilization. In one embodiment, the LITAB may be coated with a covalent DNA-binding agent used in microarray. The probe beads were subsequently hybridized in solution to a complementary oligo target which carried a covalently bound fluorophore at its 5′ end. FIG. 1(c) is LITABs imaged on a CCD with a microscope. Different objectives provide different field of views.

### 1. Barcode Bead Design

LITAB is digitally coded as represented by an image that provides for high contrast and high signal-to-noise optical detection to facilitate identification of the bead. The image is implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various barcode patterns, such as circular, square, or other geometrical shapes, can be designed as long as it represented a “1” or “0” and can be recognized by the decoder. However, LITAB is not spherical shape; it is different from the conventional latex-based spherical beads.

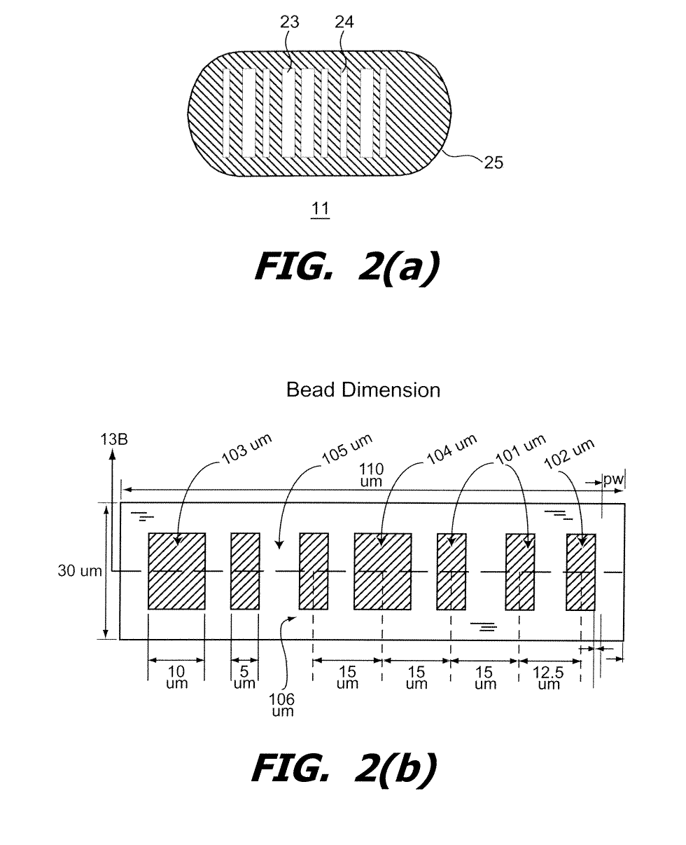

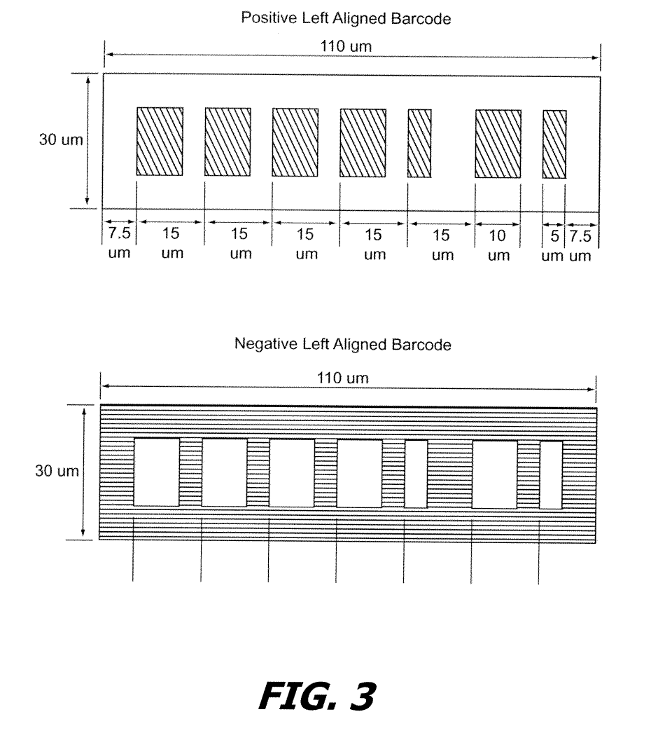

In one embodiment, the coded bead comprises a generally rectangular body having a series of alternating light transmissive and opaque sections, with relative positions, widths and/or spacing resembling a 1D or 2D bar code image (e.g., a series of narrow slits (e.g., about I to 5 microns in width) representing a “0” code and wide slits (e.g., about 1 to 10 microns in width) representing a “1” code, or vice versa, to form a binary code). FIG. 2a illustrates a coded bead, LITAB 11 in accordance with one embodiment of the present invention. The LITAB 11 has a body 25 in the shape of a flat pallet or disc. The body of the coded bead may be configured to have at least two orthogonal cross sections that are different in relative geometry and/or size. Further, the geometry of the cross sections may be symmetrical or non-symmetrical, and/or regular or irregular shape. In this particular embodiment, all three orthogonal axes are of different lengths, and the geometries of all three orthogonal cross sections are symmetrical and of regular shape. A series of wide and narrow slits 23 and 24 are provided through the body 25, which may be made of or coated with a substantially light opaque material (e.g., reflective or absorptive). The wide and narrow slits 23 and 24 represent a logical “1” and “0”, respectively, or vice versa, and collectively represent a binary code (each slit representing a bit). In this embodiment, the code is analogous to a bar code. FIG. 2a shows the dimension of rectangular beads. As shown in FIG. 2a, the bars 101 and 104 (including the LSB 102 and MSB 103) are opaque and the background is of a transparent material. The central bar region 105 encompasses the bars 101 and 104 (including MSB 103 and LSB 102) from which the identification of the particular bead is determined from imaging the barcode defined by the bars in the central bar region 105.

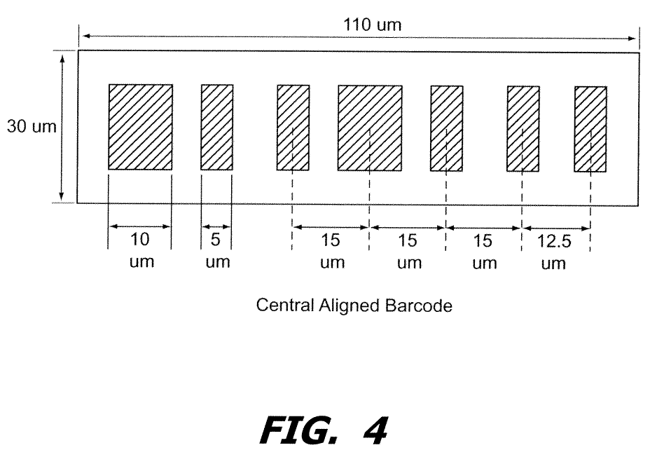

In an alternate embodiment of the present embodiment, it is more advantageous to decode the beads by detecting the structure defining the barcode without considering the boundaries of the beads. This approach of decoding is best implemented with “positive” type (FIG. 3(a)) barcodes, instead of the “negative” type (FIG. 3(b)) described above in which slits are used to define the barcodes in a opaque background of the beads. Positive barcodes are defined by opaque bars (e.g., defined by reflective surfaces) in a transparent background. Given the opacity of the bars and the transparent background, “positive” beads may provide additional advantage over the “negative” barcodes. FIG. 3, in both cases, shows the barcodes are left aligned. It means the distance between the left sides of adjacent bars in the barcode is constant, such as 15 IAM. In contrast, FIG. 4 shows the barcodes are centering aligned. In the illustrated embodiment, all the barcodes or the most significant bit (MSB)) are spaced with constant centerline spacing between adjacent bars. For a LITAB having an overall dimension of 100×30×5 pm to 300 pm×100 tm×40 pm, at least about 10 slits may be provided on the LITAB pallets to encode 6 bits to 12 bits or more, allowing 64 to 4,096 or more unique codes.

### 2. Barcode Bead Fabrication

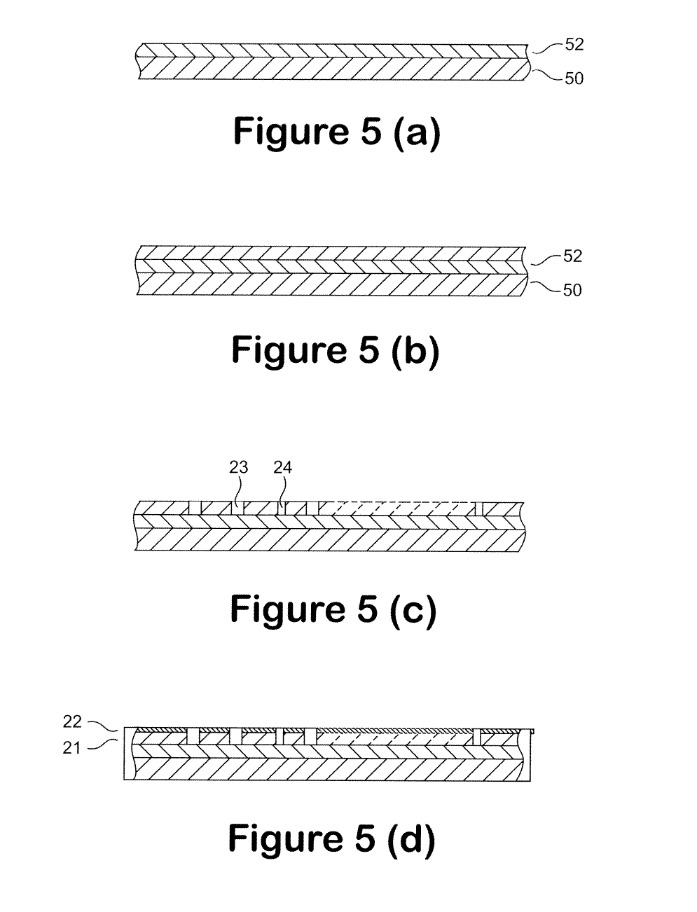

The LITAB may be fabricated using conventional methods used in thin film formation in a clean room microfabrication facility. The structure of the LITAB may be obtained using processes that may include conventional photo-lithography, printing, silk-screening, curing, developing, etching (e.g., chemical etching, ion etching, and/or other removing processes), plating, dicing, and other process steps well known in the art for such types of structure and the material involved. Referring to FIG. 5(a) to (d), in one embodiment of the process for fabricating the LITAB, a layer 52 of Ti (e.g., 100 nm) is deposited by e-beam evaporation on a substrate 50, e.g., a clean glass slide (e.g., about 1 mm thick). Ti functions as a conducting seed layer as well as a surrogate releasing layer. The body 25 of the LITAB may be formed using a layer of polymeric material. For example, a photoresist photopolymer (e.g., SU-8 and the like, as known in the art), may be utilized in creating the LITABs. A layer 21 of polymeric material is spin-coated on the Ti layer 52, and the slits 23 and 24 are formed in such layer using standard photolithographic procedures.

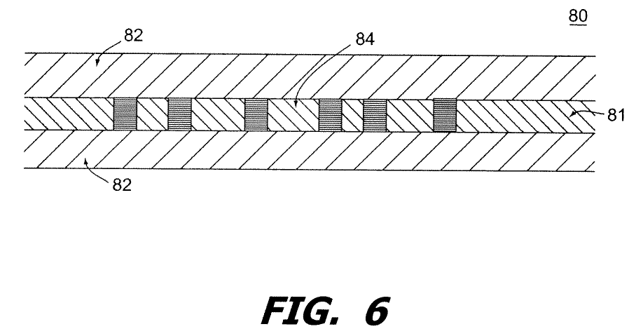

For example, the slits 23 and 24 may be defined by UV-light irradiation using a photomask defining the desired pattern of wide and narrow slits, and the planar shape of the LITAB body 25. An array of LITABs may be formed on a single substrate, each having a different slit pattern representing a different code. The photomask may also define the periphery of the array of LITAB bodies, such that the LITAB bodies are separated from one another at the end of the same photolithographic process that defines the slits. Because SU-8 is transparent, an e-beam evaporator is utilized to deposit a metal layer, such as gold (Au, 0.1 um) top layer 22 on the SU-8 layer 21 supported on the substrate 50. FIG. 6 shows an alternate embodiment of a LITAB 80, which may include a metal layer 81 as an intermediate layer sandwiched between two polymer layers 82. A barcode pattern is fabricated on the metal layer 81. For example, slits 84 of different widths and/or spacings are formed in the metal layer 81. In the illustrated embodiment, the polymer (photopolymer: SU-8) layers 82 are closed layers (i.e., no slits). The process for forming the LITAB 80 may include first forming a first photopolymer layer 82, then forming the metal layer 81 followed by etching the slits 84 therein. A second photopolymer layer 82 is formed on the metal layer 81 (e.g., by spin coating and curing), which fills the slits 84. Alternatively, the slits 84 may be first filled with another transparent material, before forming the second photopolymer layer 82. With this embodiment, surface condition could be made the same for both exposed planar surfaces of the LITAB, to provide similar surface coating and immobilization conditions. The other embodiment is to coat the LITAB with polymer or functional molecules, such as biotin, carboxylated, or streptavidin; therefore, the whole bead has the same condition for molecular immobilization.

A paramagnetic material is imbedded in the intermediate layer in the LITAB, and thus sandwiched between the first layer and second layer of polymer films. Paramagnetic materials include magnesium, molybdenum, lithium, aluminum, nickel, tantalum, Fe203, and Fe304. It is noted that the paramagnetic material on the LITAB would also function as a light blocking material, so a reflective layer is not necessary. The present invention would allow decoding based on transmitted light, even in the presence of the paramagnetic material. However, for prior art, there are magnetic beads and barcode beads, no magnetic material has been incorporated into the barcode microbeads. This is because the magnetic material being inherently dark brown, would not be compatible with the reflective bar code, which requires alternating dark and white lines.

### 3. Barcode Bead Optical Detection System

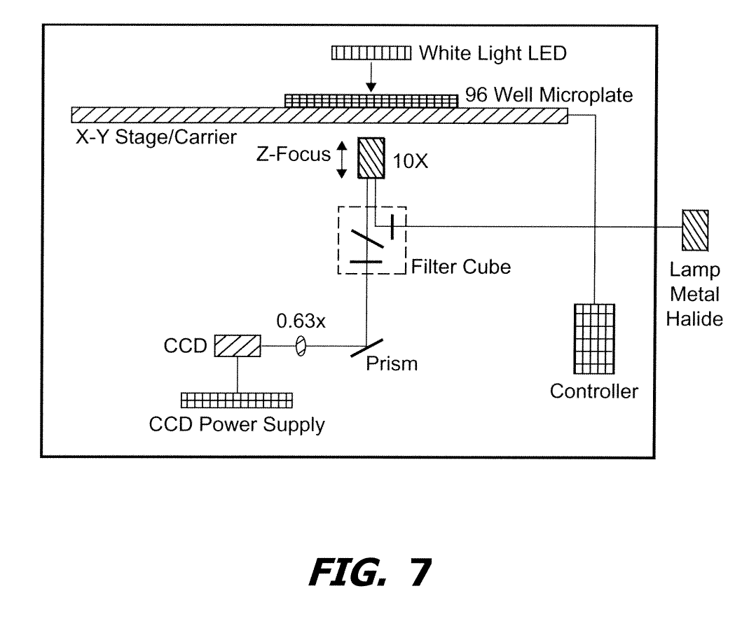

Both bar-code image and fluorescence image can be constructed on a conventional microscope or an inverted fluorescence microscope. One embodiment illustrated in FIG. 7, the digital magnetic LITAB analytical system has a white light LED source for bead pattern illumination and an optical CCD for capturing images of beads at the bottom of the support (e.g., a microwell in the illustrated embodiment). The bottom of the microwell is transparent or translucent, allowing sufficient light to pass through to the beads. A bright field light source (e.g., a white light LED) is incident from the top of the 96-well plate (e.g., via a diffuser plate to provide more uniform illumination). All current LEDs have speckle patterns or non-uniform light pattern. which cause the non-uniform light distribution and illumination. The situation becomes worse when the light is illuminated near the edge or the wall of the microwell. A light diffuser film has been made and implemented on top of the plate as a plate scaler or attached on the microplate cover. The diffuser film homogenizes the LED light pattern, thus every image frame has uniform background, which leads to much improved decoding accuracy. A scanning or translation mechanism moves the microwell relative to the optical detector and light source to image the desired wells. The optical detector can be used for both barcode image and fluorescence detection. A 1M pixels CCD should have sufficient pixels to resolve the barcode pattern on beads. Barcode illumination light source can be a white light, while fluorescence excitation light source need a wavelength that matches with the absorption of the fluorophore. Lens and optical filters are used to collect and select the excitation and fluorescence wavelength. By measuring the fluorescence intensity, we can identify which beads have positive biochemical reaction. By decoding the digital barcode image, we can identify which biological probe is immobilized on the surface of that microbead. The choice of light source depends on the fluorophore. For example, a Mercury light source or metal halide lamp facilitated with an optical filter cube offers UV to visible light excitation. A red diode laser (665 nm), and compact Argon Laser (488 nm) or green laser (530 nm) are common laser light sources for variety of fluorophores (e.g. phycoerythrin (PE), Cy3, and Cy5, etc.). Optical filter sets are designed to select particular excitation and fluorescence wavelength for various fluorophores.

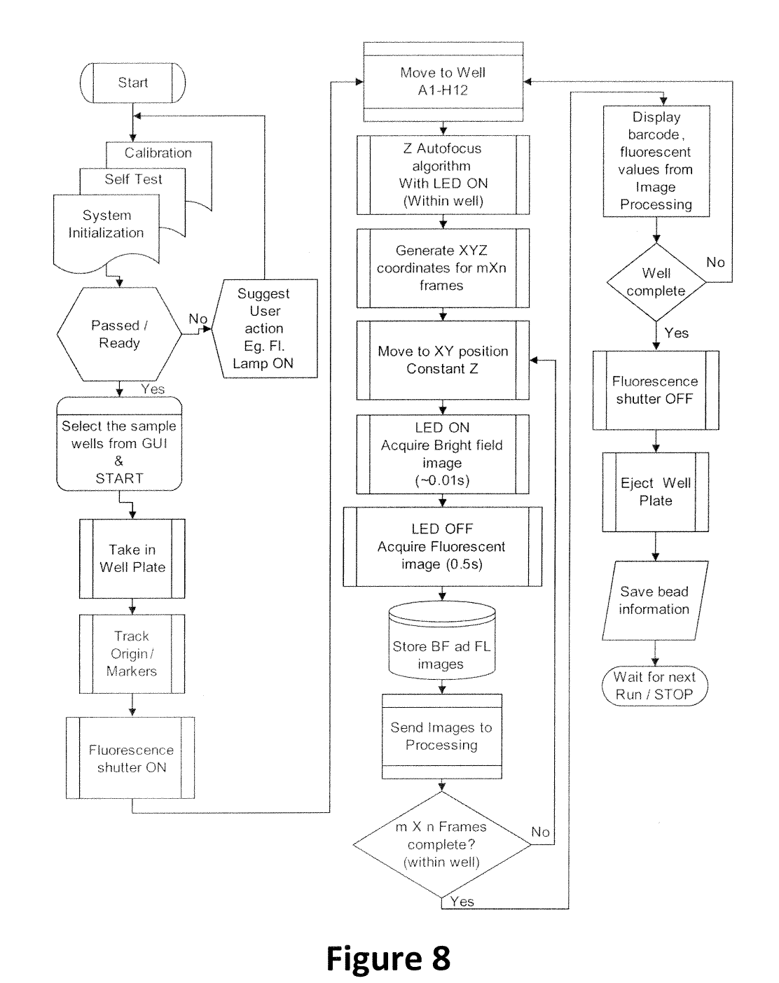

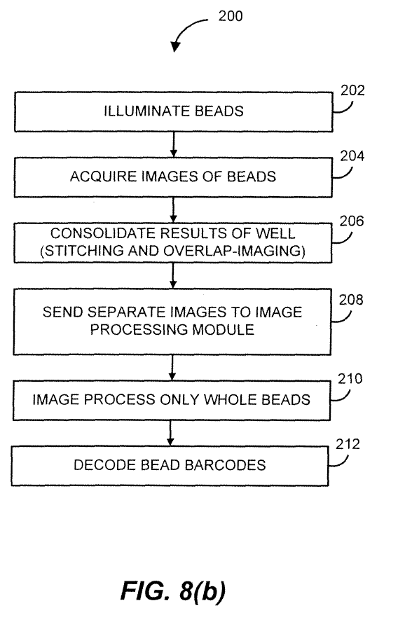

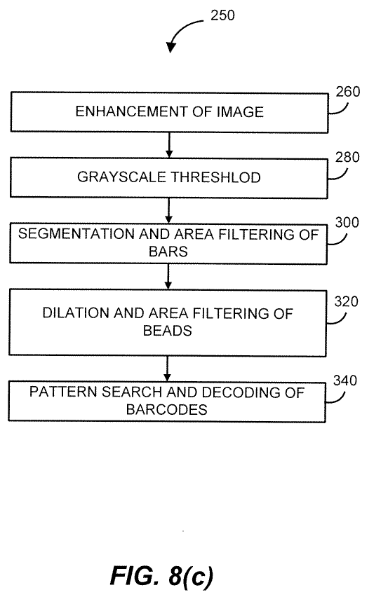

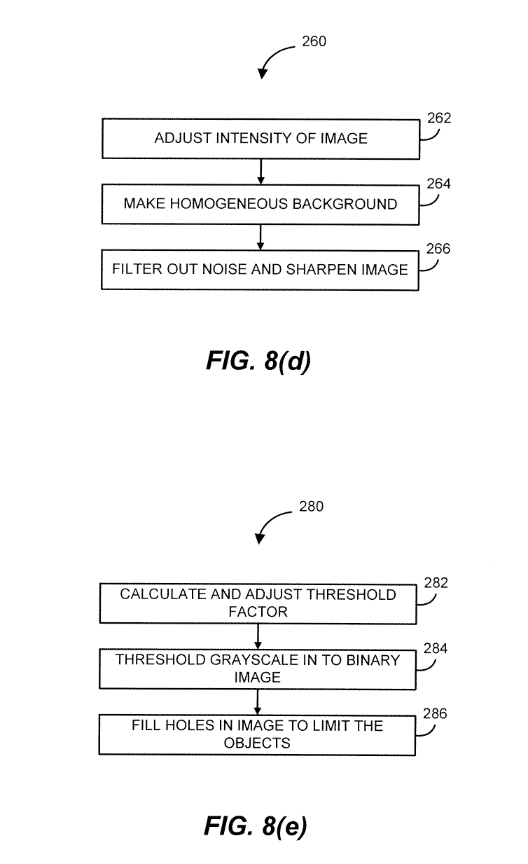

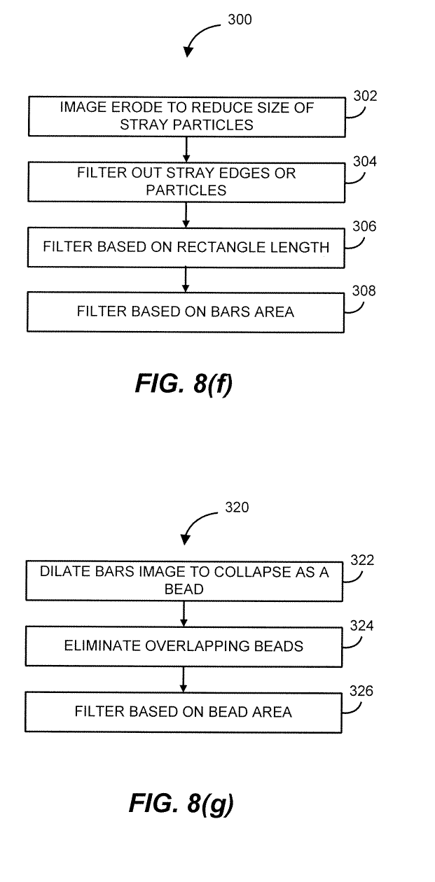

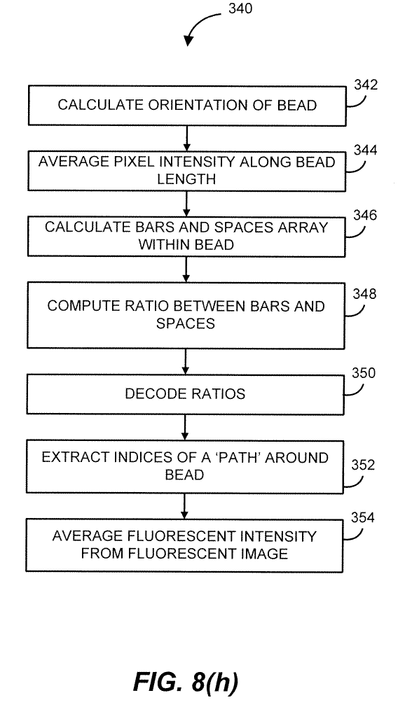

Referring to the flow diagram in FIG. 8(a) (and the system illustrated in FIG. 7), the entire image decoding and fluorescence detection system in accordance with one embodiment of the present invention is described. Upon system startup, the system goes through a startup procedure including calibration, self-test and system initialization. If startup procedure is not carried out completely or successfully, additional user action may be required to validate startup (e.g., turning fluorescence lamp on). Once startup procedure has been successfully completed, the user can initiate test procedure via a graphical user interface at the system controller/computer (e.g., select the sample wells to be imaged and processed). The sample well plate is received into the system (e.g., supported on the X-Y stage). The fluorescence shutter is turned on until all heads in the wells are imaged. If a fast shutter is used, then it does not need to be kept ON for long, which will avoid interfering with bright field image. The X-Y stage can be controlled by the system controller to access each well (A1-H12) in sequence or as desired. At each well location, the Z-focus of the lens below the well is adjusted automatically for the CCD, with the white light LED on. Depending on the optics and focus, the number of mXn frames and the XYZ coordinates of each frame are generated. The first well is accessed based the designated X—Y position. The bright field image BF is acquired (e.g., approximately 0.01s) with the white LED on. This BF image is stored for bead decoding offline (or can be real time if the processing system is fast enough). The white LED is then turned off, to allow acquisition of fluorescence (e.g., approximately 0.05s). The fluorescence image FL is also stored for further image processing. The bright field BF and fluorescence FL images can be immediately sent for image processing by the decoding and fluorescence analysis processes to identify the beads and determine fluorescence values as each frame is imaged

The randomly oriented microbeads can be decoded on a support, such as a slide or in the bottom of a microplate by imaging processing method. When beads are finally settled down and distributed on the bottom of a planar surface in a microplate, multiple beads can be decoded simultaneously with a wide viewing or scanning image camera. Microplate is a standard format for high throughput clinical assays. Each well is used for one sample; each plate holds 96, 384, or 1,536 patient samples for 96-well, 384-well, and 1,536-well, respectively. Therefore, an experiment can be performed in the microplate without taking the beads out, the image of the microbeads can be taken in the steady state with a better accuracy and sensitivity for decoding. The accuracy of decoding is very important for clinical diagnostics, because any false identification can lead to mis-diagnosis and mis-therapy. Due to the small bead size, hundreds or even thousands of beads can be displayed in the bottom of a microwell with minimal overlap. To minimize bead overlap, depend on the area of the microwell, the total number of beads is limited to a certain number. Furthermore. the non-spherical beads are tended to overlap spatially. To minimize the bead overlap and aggregation. a detection buffer solution was developed.

The detection buffer is composed of
(a) steric stabilization of bulky polymer.
(b) compatibilization of copolymer.
(c) solubilization effect of salt for hiomolecules.
(d) surface tension reduction of surfactants. or changing nature of surface properties (hydrophilic/hydro-phobic, interfacial tension, or charge character) of beads. Bulky polymer is chosen from natural polysaccharides. or synthetic polymers or copolymers. The compatibilizer is chosen from copolymers containing N-vinyl pyrrolidonc (or 1-yinyl-2-pyrrolidone). Surfactant is chosen from silicone surfactants, fluoro-surfactants. anionic surfactants, cationic surfactants. or nonionic surthctants or their combination.

### 4. Acquisition of Overlapped Bright Field and Fluorescent Images

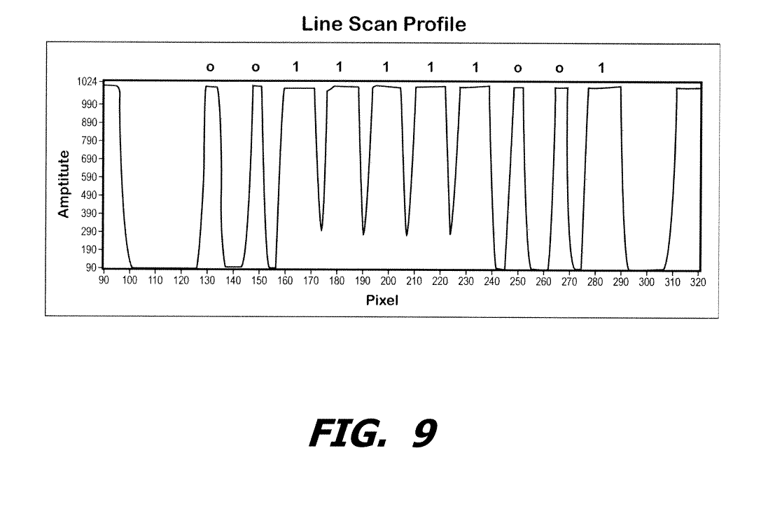

FIG. 8(b) is a flow chart illustrating an example method 200 of imaging and decoding a microbead. When the bead is illuminated (block 202) with a light beam, based on the either the “total intensity” of the transmission peak or the “bandwidth” of the transmission peak from the slit, the digital barcode either 0 or 1 can be determined by an imaging camera and a digital signal processor. As shown in the FIG. 9, the barcode patterns can be easily identified based on the peak widths. Specifically as illustrated in the embodiment shown in FIG. 9, the beads show 10-bit barcodes representing 0011111001. To image all the beads on the entire support of a single well bottom, the well bottom is scanned using the X-Y stage, to index various image frames over the entire planar area of the well bottom where beads are found (block 204). Different image frames have to be consolidated to output the results of a single well. Two techniques have been considered to consolidate the results of the whole well namely, stitching and overlap-imaging (block 206). Stitching of the image frames requires overlap imaging of 5-20% of the size of the frames. In the illustrated system, the beads are of specific dimension of 30×110 μm.

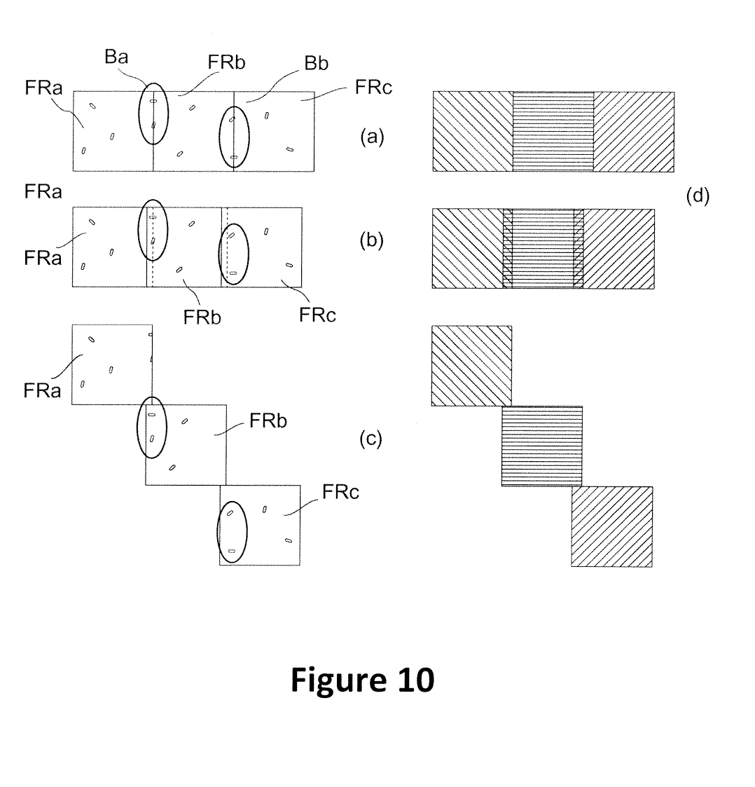

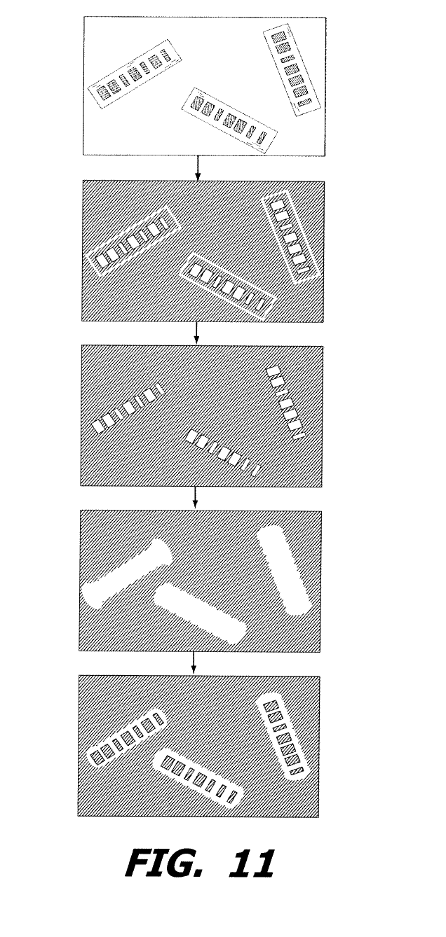

The preferred configuration is to take a large image (for example, 6-8 mm in diameter of a microwell) with sufficient optical resolution to resolve the barcode pattern (5 pm and 10 pm). If a 4× objective is used, more area can be covered. However, spatial resolution is not as good as when a 10× objective is used. If a 10× objective is used for a microwell with a diameter of 6.0-7.0 mm, it needs to be indexed to scan 5×6 frames (FIG. 10(a), image frames FRij, where ±1 to 6, j=1 to 5). With an overlapping of frames, the beads at the periphery of the frames will fall in one of the adjacent frames. The largest dimension of the bead (110 pm) and a safety margin of 10 pm are considered for overlapping. Therefore the whole well bottom is imaged with an overlapping of 120 pm at the edges in both directions. If one of the heads with a barcode pattern happen to be located between the two image frames (see beads Ba between frames FRa and Mb, and beads 11h between frames Mb and FRc. in FIG. 11(a)), each image frame FRa, FRb and Me will have a partial head or partial barcode (5 pm×15 pm) image.

If two neighboring images after being patched are slightly off in either the X or Y direction, the barcode may not be recognizable and decoding will be difficult. Therefore, a novel bead image overlapping method is used. This method is to overlap each neighboring frame FRa, FRb and FRc with an overlap of 120 pm, for example, (the long axis of the bead+margin) on X and Y direction (FIG. 10(b)). The overlapping is made so that the beads are imaged in two images, or more if overlaped in both X and Y directions. Adjacent frames will “fall fully” in at least one of the frames (as illustrated in FIG. 10(c), beads Ba fall fully in frame FRb and beads Bb fall fully in frame FRc; part of beads Ba remain on frame FRa).

Image processing is carried out in parallel to the movement of the XY stage (block 208). The separate frames with bead patterns are sent to the image-processing module as soon as they are imaged (FIG. 10(d)). The image decoding process will only process whole beads (block 210), and do not need to process the partial beads remaining in any frame. By this method, perfect image patching is not necessary, and decoding is much faster and accurate. Each well is processed frame by frame within a specified time period (e.g., 1 minute) before the mechanical movement of the stage is complete. Image processing is carried out on the fly for each well before the next well is scanned. For each image frame, bead decoding is carried out based on the bead image using the grid search process as described above (block 212). It is noted that FIG. 10 illustrates overlaps of frame edges in one of X-Y directions. Overlaps of frame edges in the other one of X-Y directions is similar for the frames. Further, it is noted that the number of frames (mXn) required to cover the entire area of beads on the support (e.g., well bottom) would depend on the detection optics, individual frame size and overall support area.

### 5. Image Processing Algorithm

As soon as a barcode image is obtained from the CCD, the image data is rapidly processed by the barcode decoding software. They are many implementations of the image-decoding algorithms. Depend on the image patterns, different algorithms may vary in terms of decoding speed or accuracy. For detection of the bars in beads, two different approaches may be implemented. One approach is to reconstruct the periphery of the bars by eroding and filling the images, using an approach based on tracking object similar to tracking the bead body discussed in the earlier embodiment. Another approach is to rely on a ‘grid search’ based routine which searches the bars in the beads in an image frame through a grid.

FIG. 8(c) illustrates an exemplary flowchart of a segmentation based algorithm 250. The algorithm includes five main sub-processes: (1) Enhancement of bright field image (block 260); (2) Grayscale threshold (block 280); (3) Segmentation and area filtering of bars (block 300); (4) Dilation and area filtering of beads (block 320); and (5) Pattern search and decoding of barcodes (block 340). Some of these processing are carried out using the mathematical software, such as toolkits available from “The Mathworks, Inc.” (e.g., MATLAB® Version 7.4.0.287 (R2007a); Jan. 29, 2007), NI Machine Vision/Labview/NI Developer Suite 2009 and Visual Studio 2009 softwares. The functions of these processes are explained in the following sections and are shown in FIG. 11.

(1) Enhancement of image: The performance of the decoding of beads depends heavily upon the quality of the image. The accuracy of the decoding process can be improved by imaging enhancement, shown using exemplary flowchart 260 IN FIG. 8(D). This image enhancement using image intensity normalization to provide uniform intensity background (block 262). Non-uniform background is often due to the non-homogeneous illumination. To achieve high image contrast of the beads, the background should be made homogeneous (block 264) first by background subtraction and normalization (block 266).

(2) Grayscale threshold: FIG. 8(e) is an exemplary flowchart 280 illustrating a possible grayscale processing routine. The bright field image of the beads has only two color components namely, black nickel bars and while bead body. However during imaging a continuous range of grayscale pixels are formed. The nickel bars can be separated from the bead body using grayscale thresholding, including calculating and adjusting a threshold factor (block 282), converting the threshold grayscale into a binary image (block 284) and filling holes in the image to limit the objects (block 286). The edge or border of the beads are also appeared in the grayscale image as noise which are removed in the successive steps of the processing.

(3) Segmentation and Area Filtering of bars: FIG. 8(f) is an exemplary flowchart 300 illustrating a routine for performing segmentation and area filter of bars. The bars in the beads are the only high contrast elements in the beads. So recognition of the beads is done by detecting the bars in the heads. The goal of image segmentation is to separate the bars in the image for further analysis. The seven bars of the beads including MSB, 5 bits and LSB are segmented in order to measure their dimension for decoding. The routine 300 includes image erosion to reduce a size of stray particles (block 302), filtering out stray edges or particles (block 304) and filtering based on a rectangle length (block 306). After the segmentation of the bars, any other objects present in the images are filtered out using the range of area of small and big bars (block 308).

(4). Dilation and Area Filtering of beads: FIG. 8(g) is an exemplary flowchart 300 illustrating a routine for performing dilation and area filtering of beads. After segmentation of the bars, each set of seven bars is considered a bead. The set of seven bars are merged together using dilation of the bars (block 322). The routine may also eliminate overlapping beads (block 324). After the bars are dilated the objects formed as beads are filtered out using the area of the beads with a tolerance (block 326). An additional filtering step may be included to remove the ring around the set of seven bars due to the edges of the beads.

(5). Pattern search and decoding of barcodes: FIG. 8(h) is an exemplary flowchart 340 illustrating a routine for performing a pattern search and decoding of barcodes. After the bead is found, the set of seven bars is matched with a pattern search. In order to decode the barcode, the widths of the transmission intensity peaks of the set of seven bars are analyzed. A half maximum line is used to calculate the widths of the peaks. In order to extract the binary bit information, 4-6 pixels are used to describe the narrow bar (‘0’) of the beads and 9-11 pixels are used to describe the narrow bar (‘I’) of the beads. Based on the ratio of the width of the bars and their adjacent spacing on the right, the digits are quantitatively decoded.

In other words, the routine 340 may include calculating the orientation of the bead (block 342), averaging the pixel intensity along the bead length (block 344), calculating the bars and spaces array within a bead (block 346), computing a ratio between bars and spaces (block 348), decoding the ratios 1.5-2.5 as ‘1’ and .r-1.4 as ‘0’ (block 350), extracting indices of a ‘path’ around the bead (block 352) and averaging the fluorescent intensity from the fluorescent image (block 354).

In order to reduce the amount of computational time for the image processing, a number of attempts have been made to improve the algorithm. The image resolution is reduced from 1 p.m/pixel to 10 μm/pixel in order to do the initial processing for segmentation of the beads. When the beads are segmented, the barcodes are extracted using the high resolution image. Another attempt is to convert the image decoding algorithm from MATLAe to C and pre-compile the C program before execution. This tremendously improves the speed of execution of the image decoding software. Finally the decoding program is run with a co-processor such as NVIDIA and using a CUDA library to couple the program with the co-processor. This system has as many as 128 co-processors to execute the program in a parallel fashion.

Two different image processing approaches for decoding the “positive” and negative barcode beads may be implemented. One is based on object tracking of the bars of the beads in case of positive barcode beads and the other is based on detecting the body of the beads in the case of negative barcode beads. The object tracking based on detecting the set of bars is described earlier. The method of tracking the bead body is for the negative beads where the bead is detected using the boundary of the beads. The image processing steps involves a combination of routines such as dilation, erosion, edge detection, mask creation.

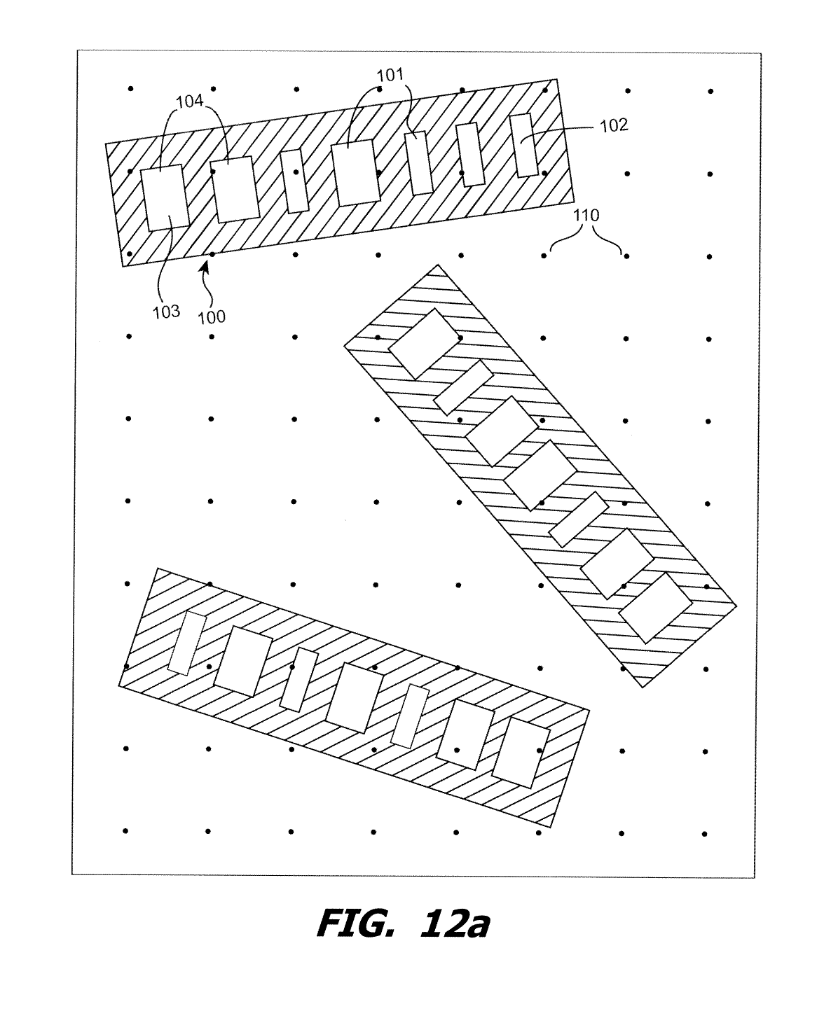

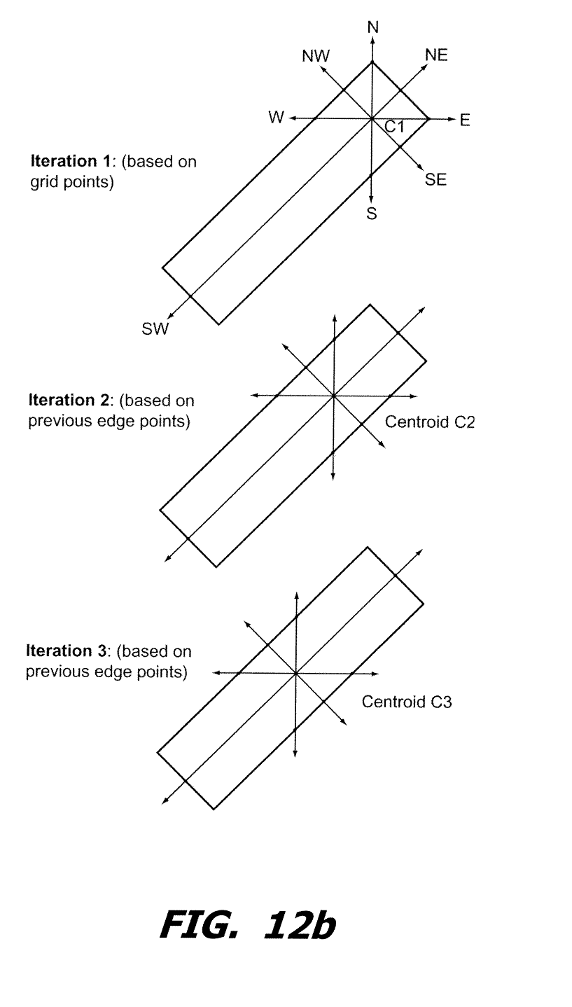

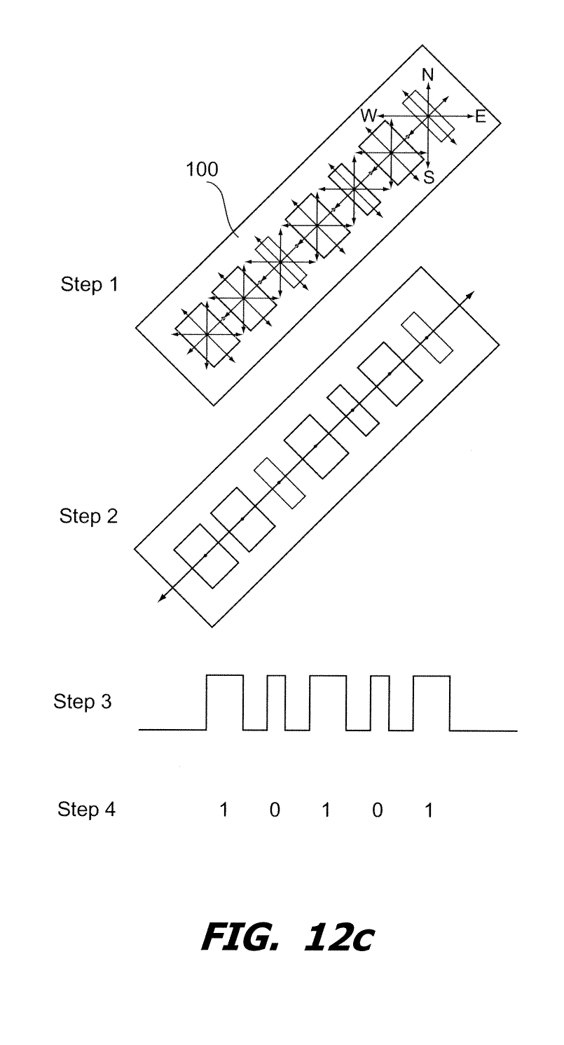

Grid search algorithm for barcode decoding: Grid search routine in and by itself is a known technique, which with the disclosure herein, can be effectively applied for bead decoding. The grid search routine used for decoding the beads discretizes the image frame into grids on x and y directions as shown in FIG. 12a. (In FIG. 12a, for purpose of ease of illustration only, the opaque bars are shown in white, and the transparent background of the bead is shown cross-hatched.) The grid pitch is a function of the smallest dimension of the beads. In this case of rectangular beads 100, the grid pitch is half the width of the beads (or 15 in the illustrated example). Accordingly, at least one of the grid points 110 falls on the bead area. Using the grid point 110, directional lines are drawn towards North, South, East, West, NE, SW, SE, NW directions, reaching the edges of the bead 100 (see also FIG. 12b). The points where the directional lines intersect the edges of the head 100 are averaged to estimate the location of the geometrical centre of the rectangular bead. This initial estimated center location is refined by several iterations, each with similar extending directional lines from the center (e.g., C1) found in the immediate preceding iteration, to obtain a new estimated center location (e.g., C2). After several iterations of center points, the geometrical center (e.g., centroid C3) may be determined at convergence (or equilibrium) of the estimates, and the major axis of the bead can also be determined. Using the major axis of the bead, decoding of the bead by decoding the barcode therein can be simply accomplished. The bars are all aligned along the major axis of the bead, and the sequence of wide bar 104 and narrow bar 101 can be determined from the image, with the MSB and LSB as reference points for the barcode.

Alternatively, the above grid search routine can be adapted for decoding the set of bars directly. In this case the grid search algorithm searches for the bars at each grid points and construct the contour of the bars in order to decode the bead. The grid pitch is half the width of the smallest bars/slits. In the illustrated example, the grid pitch is 2.5 1.1M.

There are four major steps in the grid search algorithm (shown in FIG. 12c) as follows:
1. Establish a rectangular search grid and search at each grid point for a bar.
2. Determine the axis of the bars from the centroids of the bars.
3. Determine the intensity profile of the bars of the beads.
4. Compute the overall bar code based on the sequence of bars determined above.

### Fluorescence Detection

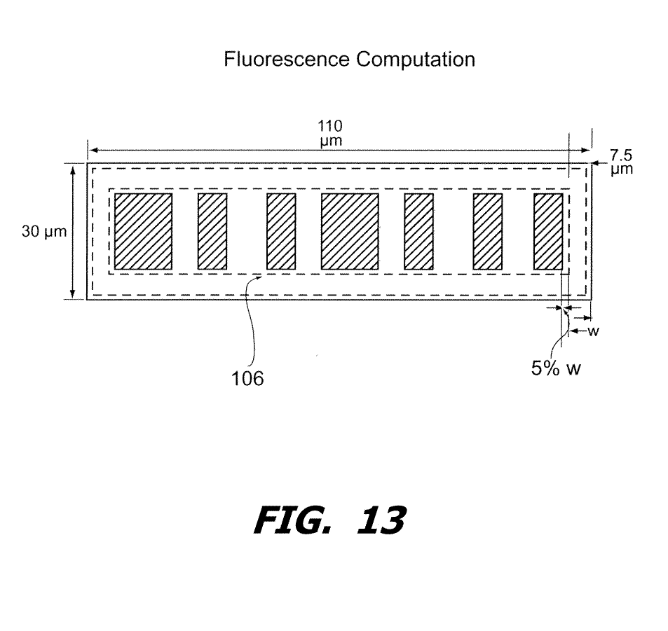

Fluorescence of the beads is calculated using the area between the two concentric rectangles in dotted lines illustrated in FIG. 13. The principle is based on quantifying the fluorescence along the path outside the barcode but inside the bead. This is the periphery region 106, which is 5% inside of the edge of the bead and 5% outside the central slit region 105 of the bead. The width of the path is pw, constant around the periphery of the bead. In this area there is no influence of the barcode metal surface on the reflection of fluorescence light. The average fluorescent value is calculated for the pixels along the path area of the beads in the fluorescence image. The path area pixel indices extracted from the bright field images are used for fluorescence calculation.

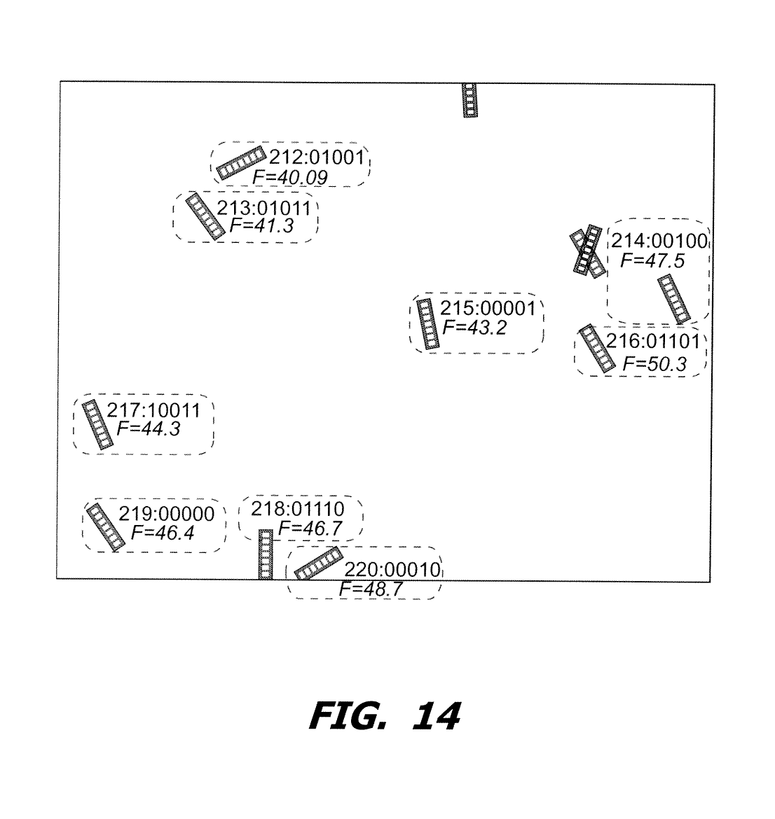

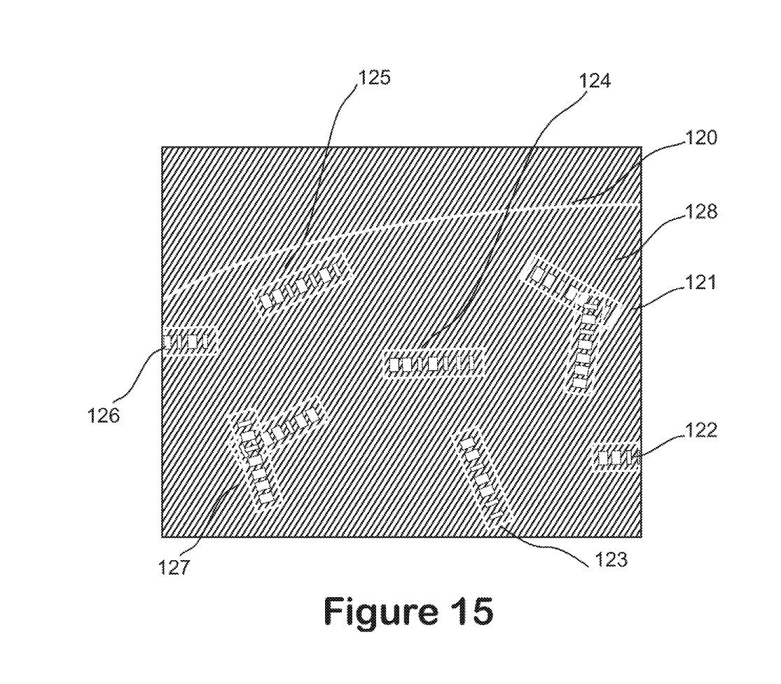

As was in the case of the earlier embodiment, the surface of the bead is prepared to provide a probe surface that can immobilize, hybridize, react and/or bond with a target sample carrying a fluorophore. The planar surface of the bead is continuous and uniform, without surface pits. However, at the opaque metal region, the fluorescence intensity is not uniform and so the fluorescence region 106 (path region) is the region from which the result of molecular immobilization is detected, even though immobilization takes place over the entire planar surface of the bead including the central bar region 105. By integrating the total fluorescence signal obtained from the area 106, confined within the dash line, as shown in FIG. 13, constant fluorescence value can be achieved. FIG. 14 is an exemplary image of beads in a single image frame. The bars in each bead appear dark on a light background (i.e., the “path” region for detected fluorescence). The image is imposed with data from bead decoding and fluorescence detection. In the image, the barcode on the beads, the delineation of the fluorescence region and the values from fluorescence calculation are shown as “F=” numbers.

The strategy for the image processing for different types of bead designs is summarized in the following.

1. Negative Beads without Border

Negative beads, as shown in FIG. 3b, are beads with black background and transparent bars. Metal is present everywhere in the beads except on the code bars. The code bars are also called slits or window. Since metal is present all the way to the edge, these beads are black all the way to the edge. Image processing is more difficult in these beads because is difficult to separate out touching beads and watershed algorithm is deployed.

In accordance with this embodiment, a watershed algorithm in Matlab is applied to isolate the beads. Because the higher density of black pixels (due to opaque area) correspond to edges of the beads, the watershed transform finds ridgelines in an image and treat the surfaces enclosed by dense pixels as beads. Normally the beads have constant area and therefore each bead is separated from the image after filtering using their areas. In addition, the beads are recognized based on the slits (bars) present in the beads. The outline of the slits set is extracted using structure element transformation and filtration. With the good clarity of the slits, any noise in the background of the image is removed. The watershed algorithm in Matlab works for black and white images and so the image is first converted to black and white image.

### 2. Positive Beads

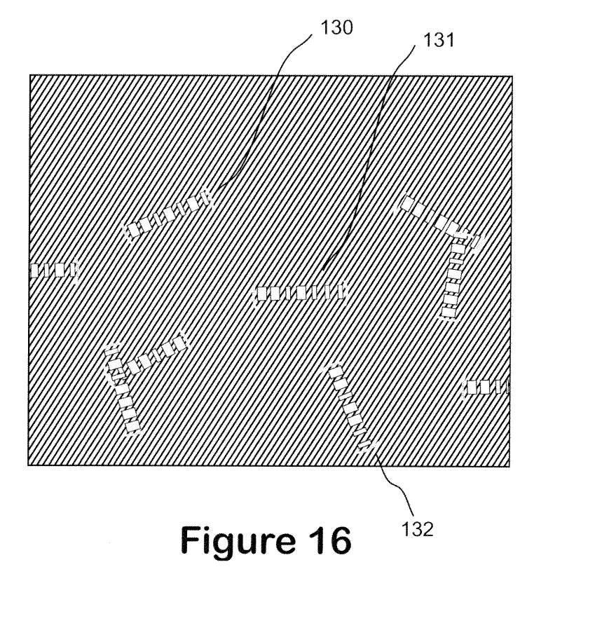

In these positive beads, as shown FIG. 3a, the metal bars are encapsulated in photopolymer and so they appear with transparent background. The image processing steps presented earlier are suitable for these beads. The barcode decoding from a processed image could also be done, for example, using a geometry pattern recognition of the barcodes as illustrated in the following set of six figures (FIGS. 15-20) corresponding to six high level steps.

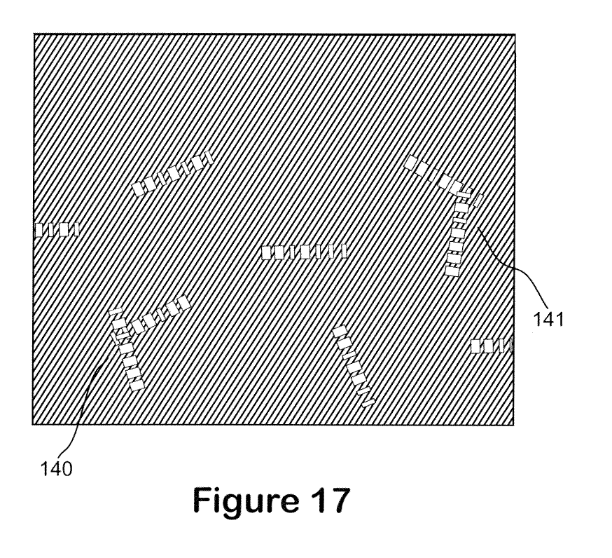

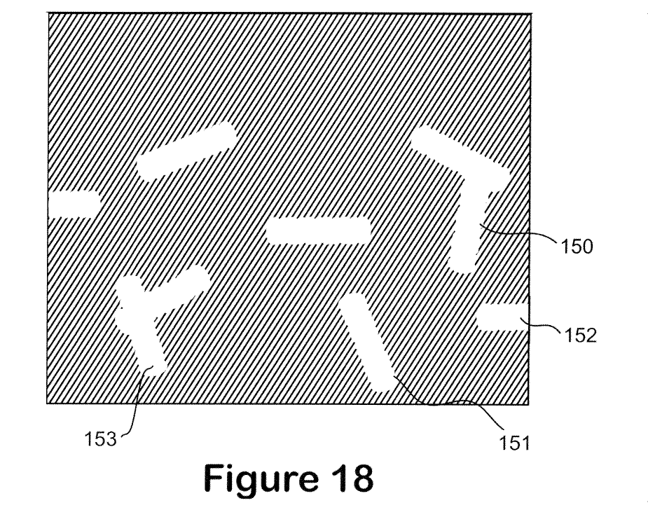

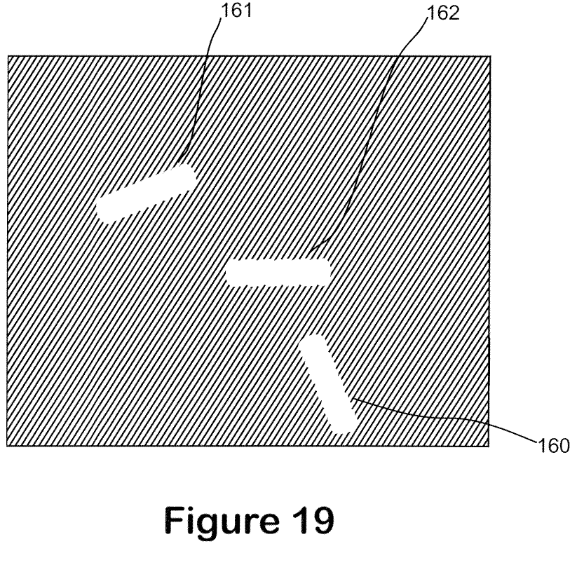

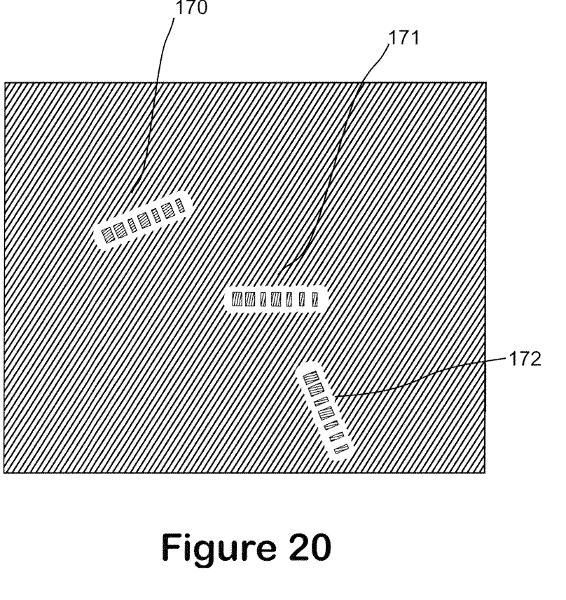

In a first step (FIG. 15) the gray scale images are undergone background correction and binary thresholding. The accuracy of the decoding process can be improved by imaging enhancement and normalization. Binary thresholding is needed for data reduction in order to carry out the image processing at higher speed. The edge of the well (120) is still visible in this image. In this image example, overlapping beads (121,127), partial beads (122, 126) and good beads (123, 124, 125) are shown in black background (128). In the second step (FIG. 16), the segmented images are filtered for the area of bars but the resultant image is left with a few stray patterns from the edge of the bead. The objects in the image with areas outside of the ranges of the areas of ‘0’ bars and ‘1’ bars will be removed. But still there will still be some edges (130, 131) on each end of the length of the bead with area that will fall in the range which may not have removed by this areal filtering. The third step (FIG. 17) is continued with filtering using a bounding box around the bead in order to remove edges on both side of the length of the bead. This process will completely remove all stray edges or objects in the image. But the overlapping edges (140, 141) will still remain in the image. In the fourth step (FIG. 18) the bars are dilated so that they collapse as a single object so that individual beads are converted in to objects (150, 151, 152). In this case there will still overlapping beads (150, 153) in the image. The fifth step (FIG. 19) filters the image with area of the bead so that partial beads or overlapping beads are removed from the image. The seven bars of the beads including MSB, 5 bits and LSB are segmented as good beads (160, 161, 162) in order to measure their dimension for decoding. In the final step (FIG. 20), the beads are matched geometrically using computer generated barcode patterns so that barcode detection is performed. The beads are decoded as 10101 (170), 101011 (171) and 101011 (172). Alternatively, the widths of the intensity peaks of the set of seven bars are analyzed. To decode the beads, 4-6 pixels are used to describe the narrow bar (‘0’) of the beads and 9-11 pixels are used to describe the narrow bar (‘1’) of the beads. Further, based on the ratio of the width of the bars and their adjacent spacing on the right, the digits are quantitatively decoded.

### 3. Surfboard Beads (Curved on Both Sides)

These beads, as shown in FIG. 2a, are designed for flowing smoothly in micrfluidic channels so that the barcodes can be read using spatial pixels in a line camera or temporally in a PMT. While adapting the same beads for image processing based multiplexed diagnostics platforms involve special image processing routines such as Hough transform and Sobel filter, in order to extend the decoding to curved rectangular shaped beads. Geometrically, the bead is composed of a rectangle in the middle and two semi circles on either ends. One of the semi circles is larger than the other and so they serve as MSB and LSB bits. In order to decode the barcodes, image processing is done to erode the bead except the semicircles. A filter based on area can extract only the MSB semicircle from the beads. This solid semi circle image is reduced to edged image using a ‘Sobel filter’. The whole image consists of a curve forming semicircle and a straight line. Using Hough transform in MATLAB® the straight lines are identified. Based on the straight-lines, boxes of lengths of the barcode portion of the beads are constructed towards the direction perpendicular to the straight lines but away from the semicircular regions. Extraction of the barcode is accomplished by plotting the intensity inside the constructed boxes.

### 4. Left Aligned Bars in Bead

The bar segments in the bead consists of a ‘transparent space’ component and a ‘black bar component. In one case the bar is aligned at the center of the bead segment so that the spaces are divided equally on either side of the bar. This is termed as centre aligned bars in bead. One advantage of left aligned bars system, as shown FIG. 3, is that the decoding is done with higher accuracy because the spacing between barcode segments is constant. In this left aligned bars system, the bars are separated out in the bar segment and are placed on the left with space on the right. While decoding, the ratio between bars and space within a bar segment is computed to qualify as ‘1’ or ‘0’ bit.

5. Shortened Bead with No Spaces Between Code Segment

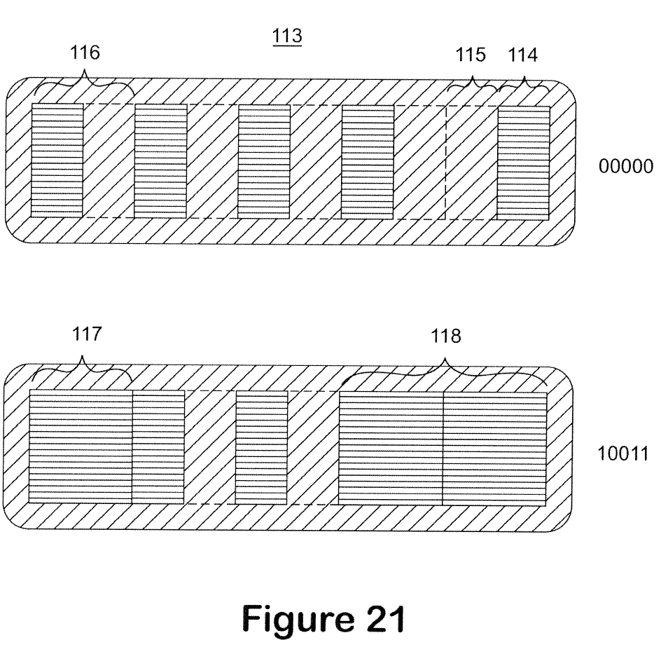

In order to reduce the length of the beads further, a 5 um space that exists in between bar segments (in the previous design) are removed as shown in FIG. 21. In this case a bar segment consist of a 5 um bar (114) and 5 um space (113) to serve as ‘0’ bit (116) while bar segment with a 10 um bar serves as ‘1’ bit (117). In this barcoding system, the bars merge for repeated ‘1’ bits (118). A border of less than 5 um (115) width helps in the decoding of the barcode in the case of touching beads. Further the border helps in the quantification of fluorescence. The MSB and LSB bits are further removed in this design while majority of the left aligned bar segments in the barcode accounts for MSB and LSB bits. Further the first bit is left aligned and the last bit is right aligned in order to keep the barcode length constant. The majority of the other bits will decide the direction of the barcode. If the majority of the bits read are right aligned then the barcode has to be reversed.

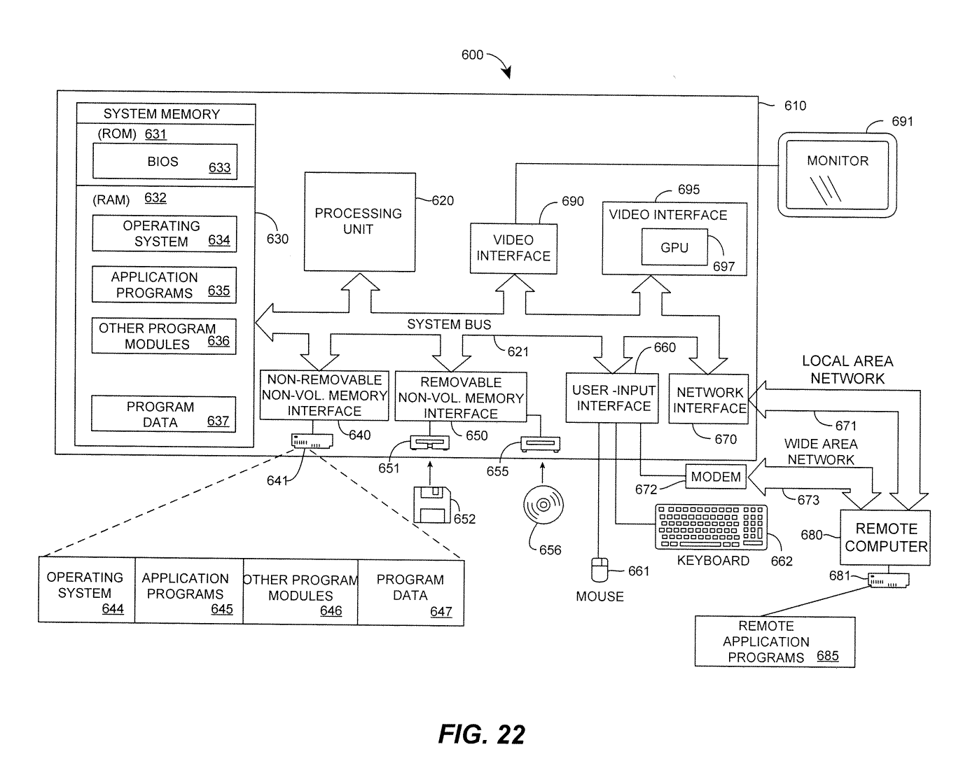

Referring again to the flowcharts described above, at least some of the blocks may be implemented utilizing the controller illustrated in FIG. 7. The controller may be part of a computer system, an example of which is illustrated in FIG. 22. FIG. 22 thus illustrates an example computing device in the form of a computer 610 that may be used to process the images discussed above.

Components of the computer 610 may include, but are not limited to a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (USA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 20 through input devices such as a keyboard 662 and cursor control device 661, commonly referred to as a mouse, trackball or touch pad. A camera 663, such as web camera (webcam), may capture and input pictures of an environment associated with the computer 610, such as providing pictures of users. The webcam 663 may capture pictures on demand, for example, when instructed by a user, or may take pictures periodically under the control of the computer 610. Other input devices (not shown) may include a microphone, joystick, game pad, satellite dish, scanner, or the like. These and other input devices are often connected to the processing unit 620 through an input interface 660 that is coupled to the system bus, but may be connected by other interface and bus structures, such as a parallel port, game port or a universal serial bus (USB). A monitor 691 or other type of display device is also connected to the system bus 621 via an interface, such as a graphics controller 690. An additional graphics controller 695 with may be connected to the system 621, where the GPU 697 of the additional graphics controller 695 may be used, in conjunction with one or more virtual machines and a suitable mechanism for offloading floating point calculations to the GPU 697, such as Compute Unified Device Architecture (CUDA), Open Computing Language (OpenCL), and so on, in manned similar to that described in reference to FIG. 1.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681.

The communications connections 670, 672 allow the device to communicate with other devices. The communications connections 670, 672 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

1. A method for using a computer to image and decode a plurality of randomly oriented, digitally coded microbeads in a microwell, comprising:
illuminating the plurality of digitally coded microbeads in the microwell;
acquiring a plurality of images of a portion of the plurality of digitally coded microbeads in the microwell;
consolidating the plurality of acquired images;
image processing only whole microbeads in each of the plurality of acquired images by:
enhancing each of the plurality of acquired images;
applying a grayscale threshold to each of the plurality of acquired images;
applying segmentation and area filtering of a plurality of bars;
performing dilation and area filtering of identified microbeads;
performing a pattern search and decoding of a barcode on each of the identified microbeads; and
storing in a memory the decoded barcode for each of the identified microbeads.

2. The method of claim 1, wherein consolidating the plurality of acquired images comprises stitching of the plurality of acquired images.

3. The method of claim 1, further comprising minimizing a microbead overlap by application of a detection buffer solution to the microwell.

4. The method of claim 3, wherein the detection buffer solution comprises (a) a polymer selected from the group consisting of natural polysaccharides, and synthetic polymers and copolymers; (b) a compatibilizer comprising copolymers containing N-vinyl pyrrolidone or 1-vinyl-2-pyrrolidone and (c) a surfactant.

5. The method of claim 1, wherein enhancing each of the plurality of acquired images comprises:
adjusting an intensity of each acquired image,
making a homogeneous background, and
filtering out noise and sharpening each acquired image.

6. The method of claim 1, wherein applying a grayscale threshold to each of the plurality of acquired images comprises:
calculating and adjusting a threshold factor,
converting a threshold grayscale to a binary image, and
filling one or more holes in the acquired images to limit a number of objects.

7. The method of claim 1, wherein applying segmentation and area filtering of a plurality of bars comprises:
performing image erosion to reduce a size of stray particles,
filtering out stray edges or particles,
filtering based on a rectangle length, and
filtering out any remaining objects in the acquired images using a range of area of small and big bars.

8. The method of claim 1, wherein performing dilation and area filtering of the identified microbeads comprises:
dilating a plurality of bars,
eliminating overlapping beads, and
filtering the acquired images to remove a ring around the plurality of bars.

9. The method of claim 1, wherein performing a pattern search and decoding of a barcode on each of the identified microbeads comprises:
calculating an orientation of the identified microbeads,
averaging a pixel intensity along a microbead length,
calculating the bars and spaces array within each microbead,
computing a ratio between the bars and spaces,
decoding the ratios,
extracting indices of a ‘path’ around each microbead, and
averaging a fluorescent intensity from a fluorescent image.

10. A computer system to image and decode a plurality of randomly oriented, digitally coded microbeads in a microwell, comprising:
a processor;
a memory coupled to the processor;
wherein the memory has stored therein computer-readable instructions that are executable by the processor, wherein the instructions, when executed by the processor, cause the processor to:
acquire a plurality of images of a portion of the plurality of digitally coded microbeads in the microwell;
consolidate the plurality of acquired images by stitching;
image process only whole microbeads in each of the plurality of acquired images;
adjust an intensity of each acquired image;
filter out noise and sharpen each acquired image;
apply a grayscale threshold to each of the plurality of acquired images, which includes calculating and adjusting a threshold factor and converting a threshold grayscale to a binary image;
apply segmentation and area filtering of a plurality of bars;
perform dilation and area filtering of identified microbeads;
perform a pattern search and decoding of a barcode on each of the identified microbeads; and
store in the memory the decoded barcode for each of the identified microbeads.

11. The computer system of claim 10, wherein the instructions to apply segmentation and area filtering of the plurality of bars comprise instructions to:
perform image erosion to reduce a size of stray particles,
filter out stray edges or particles,
filter based on a rectangle length, and
filter out any remaining objects in the acquired images using a range of area of small and big bars.

12. The computer system of claim 10, wherein the instructions to perform dilation and area filtering of the identified microbeads comprise instructions to:
dilate a plurality of bars,
eliminate overlapping beads, and
filter the acquired images to remove a ring around the plurality of bars.

13. The computer system of claim 10, wherein the instructions to perform a pattern search and decoding of a barcode on each of the identified microbeads comprise instructions to:
calculate an orientation of the identified microbeads,
averaging a pixel intensity along a microbead length,
calculate the bars and spaces array within each microbead,
compute a ratio between bars and spaces,
decode the ratios,
extract indices of a ‘path’ around each microbead, and
average a fluorescent intensity from a fluorescent image.

14. A computer-readable medium for use with a computer system to image and decode a plurality of randomly oriented, digitally coded microbeads in a microwell, the computer-readable medium recording therein a message dispatch program that, when executed on a processor, causes a computer to execute a process comprising:
illuminating the plurality of digitally coded microbeads in the microwell;
acquiring a plurality of images of a portion of the plurality of digitally coded microbeads in the microwell;
consolidating the plurality of acquired images;
image processing only whole microbeads in each of the plurality of acquired images by:
enhancing each of the plurality of acquired images including adjusting an intensity of each acquired image;
applying a grayscale threshold to each of the plurality of acquired images including calculating and adjusting a threshold factor;
applying segmentation and area filtering of a plurality of bars including performing image erosion to reduce a size of stray particles;
performing dilation and area filtering of identified microbeads including eliminating overlapping beads;
performing a pattern search and decoding of a barcode on each of the identified microbeads including calculating an orientation of the identified microbeads, averaging a pixel intensity along a microbead length, calculating the bars and spaces array within each microbead, and computing a ratio between the bars and spaces; and
storing the decoded barcode for each of the identified microbeads.
